(19) United States
(12) Patent Application Publication
(10) Pub. No.: US 2008/0151560 A1
(43) Pub. Date: Jun. 26, 2008

(54) Frame structure with built-in illumination device

(76) Inventor: Hsiu-Hui Chang, Taipei (TW)

Correspondence Address: BACON & THOMAS, PLLC, 625 SLATERS LANE, FOURTH FLOOR, ALEXANDRIA, VA, 22314, US

(21) Appl. No.: 11/822,765

(22) Filed: Jul. 10, 2007

(30) Foreign Application Priority Data
Dec. 25, 2006 (TW) 095222787

(51) Int. Cl. F21V 29/00; F21V 23/04; F21V 7/00

(52) U.S. Cl. 362/373; 362/295

(57) ABSTRACT

A frame structure with a built-in illumination device is provided. The frame structure includes a bottom plate, carrying a decorating object; a sidewall, having a sidewall height determined depending on a 3D height of the decorating object, and surrounding the bottom plate; an outer framework, disposed along the sidewall and covering the sidewall; an illumination device, mounted on the sidewall at any position, and providing an electric switch connected to an external power source; and a reflection board, adhered onto the illumination device at a corresponding position, so as to reflect light rays emitted by the illumination device to enhance luminance.

### BACKGROUND OF THE INVENTION

1. Field of Invention

The present invention relates to a frame structure, and more particularly to a frame structure with a built-in illumination device.

2. Related Art

In a conventional frame structure, the frame is formed by the assembly of a bottom plate, a sidewall (optional, since as for the frame for pictures, the thickness will not be considered, and in most circumstance, the sidewall is not required unless the decorating object has a height), and an outer framework in accordance with a decorating object or picture itself, so as to protect the decorating object or picture or improve beautifying effect.

The frame is always displayed in the places in need of illumination, and usually an additional illumination device is used to reinforce the light. Thus, FIG. 1 is a schematic view of a conventional frame structure using an external illumination device. The common conventional frame 10 usually uses an external illumination device 20 to compensate or enhance the luminance of the illumination. However, as being limited by the light-emitting angle or the illuminance of the light source, the beautifying effect of the decorating object or the picture cannot be vividly and perfectly delivered. Due to the insufficient light rays or improper illuminating angle, the beautifying effect of the decorating object or the picture is greatly deteriorated, although the material of the frame or the fabricating process are good, so it is a shortcoming.

Therefore, a frame structure with a built-in illumination device has become a topic attracting current attention.

### SUMMARY OF THE INVENTION

In view of the above problems, the present invention is mainly directed to providing a frame structure with a built-in illumination device. The frame structure mainly includes a bottom plate, carrying a decorating object; a sidewall, having a sidewall height determined depending on a 3D height of the decorating object, and surrounding the bottom plate; and an illumination device, mounted on the sidewall at any position, and providing an electric switch connected to an external power source.

The electric switch can be a wireless remote control switch or can be directly connected to a power socket through electric wires.

The design of the present invention further includes an outer framework disposed along the sidewall and covering the sidewall. Mainly, an ornamental outer frame is added on the conventional frame. Although the design is a common outer frame body, it is not intended to limit the scope of the present invention. That is, although the ornamental outer frame is a common design in the common frame, it should be understood that the substantial design of the outer frame is not the necessary feature directly related to the present invention.

Further, the present invention further provides a reflection board adhered onto the illumination device at a corresponding position, so as to reflect light rays emitted by the illumination device to enhance luminance. The reflection board is one selected from among a combination of mirror glass, aluminum sheet, and foil, but it is not intended to limit the scope of the present invention.

In addition, the sidewall has a design of a heat dissipation hole. It is also the technical feature of the present invention. The frame structure is in a closed frame space, so the problem of heat generating of the illumination device must be solved, so as to prevent temperature in the framework from continuously rising. Therefore, the design of the heat dissipation hole is provided to serve as an outlet hole for heat dissipation.

The feature and the practice of the present invention will be illustrated in detail as follows with reference to t preferred embodiments accompanying with drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional frame structure using an external illumination device;

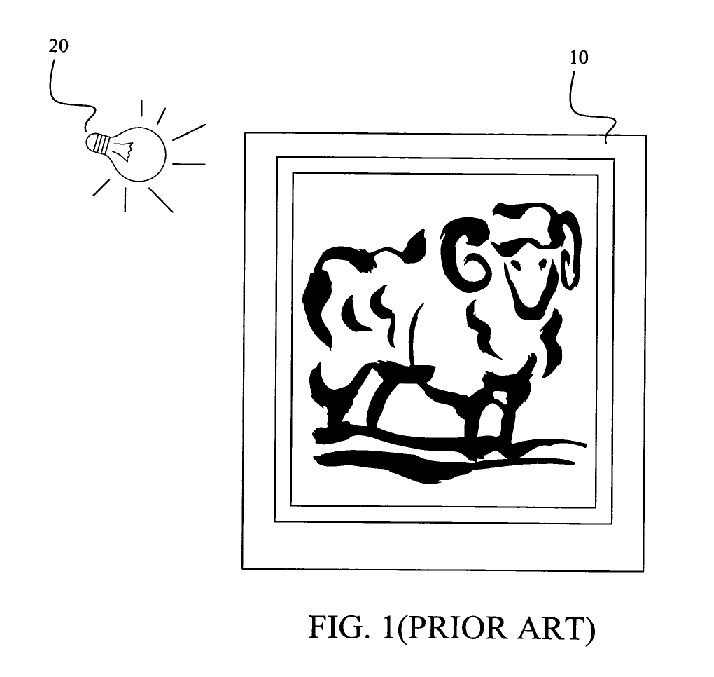

FIG. 2 is a schematic view of a frame structure with a built-in illumination device according to a first embodiment of the present invention;

FIG. 3 is a schematic view of a frame structure with a built-in illumination device according to a second embodiment of the present invention;

FIG. 4 is a schematic view of a frame structure with a built-in illumination device according to a third embodiment of the present invention; and

FIG. 5 is a schematic view of structures of upper, left, and right sides of the frame structure with a built-in illumination device of the present invention.

### DETAILED DESCRIPTION OF THE INVENTION

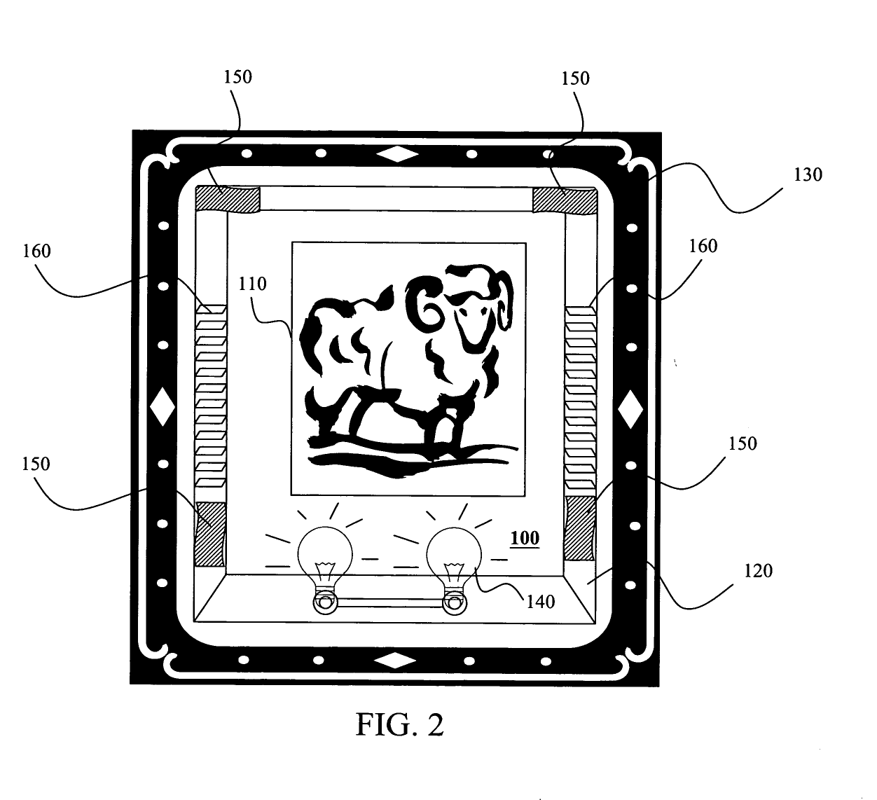

The present invention provides a frame structure with a built-in illumination device. Referring to FIG. 2, the frame structure with a built-in illumination device according to a first embodiment of the present invention is shown. The frame structure with a built-in illumination device includes a bottom plate 100, carrying a decorating object 110; a sidewall 120, having a sidewall height h determined depending on a 3D height of the decorating object 110, and surrounding the bottom plate 100; an outer framework 130, disposed along the sidewall 120 and covering the sidewall 120; an illumination device 140, mounted on the sidewall 120 at any position, and providing an electric switch connected to an external power source (not shown); and a reflection board 150, adhered onto the illumination device 140 at a corresponding position, so as to reflect light rays emitted by the illumination device 140 to enhance luminance.

The electric switch can be a wireless remote control switch or can be directly connected to a power socket. The reflection board 150 is one selected from among a combination of mirror glass, aluminum sheet, and foil, but it is not intended to limit the scope of the present invention. The sidewall 120 further has a design of a heat dissipation hole 160 to prevent temperature in the framework from continuously rising.

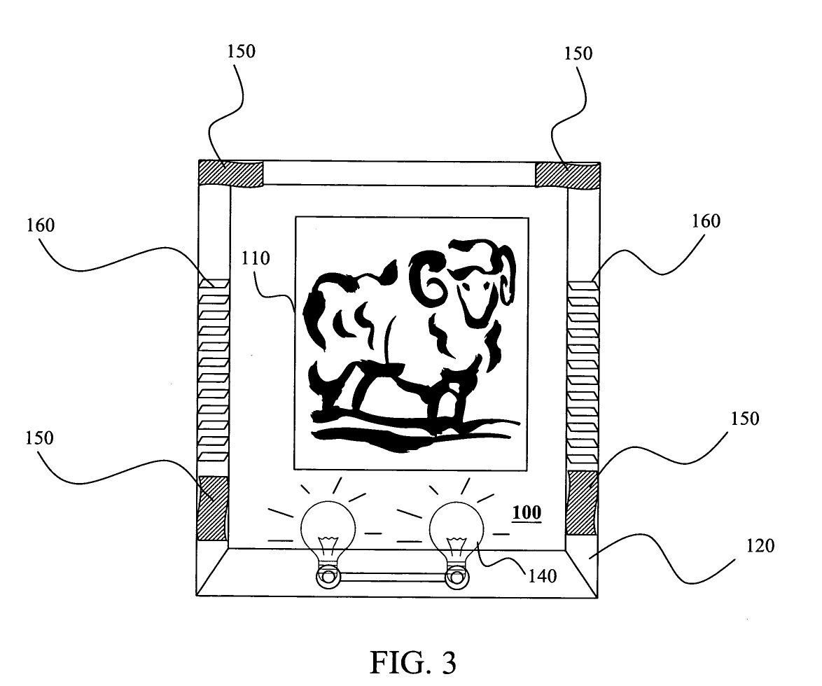

Then, referring to FIG. 3, a frame structure with a built-in illumination device according to a second embodiment of the present invention is shown. The frame structure includes a bottom plate 100, carrying a decorating object 110; a sidewall 120, having a sidewall height h determined depending on a 3D height of the decorating object 110, and surrounding the bottom plate 100; an illumination device 140, mounted on the sidewall 120 at any position, and providing an electric switch connected to an external power source (not shown); and a reflection board 150, adhered onto the illumination device 140 at a corresponding position, so as to reflect light rays emitted by the illumination device 140 to enhance luminance.

As compared with the first embodiment, the frame structure with a built-in illumination device of the second embodiment emphasizes that the spirit of the present invention can also be achieved without using the outer framework 130. That is, for the frame structure with a built-in illumination device, the outer framework 130 is an optional structure, and is selected according to the practical requirements of the user. The electric switch can be a wireless remote control switch or can be directly connected to a power socket. The reflection board 150 is one selected from among a combination of mirror glass, aluminum sheet, and foil, but it is not intended to limit the scope of the present invention. The sidewall 120 also has a design of a heat dissipation hole 160, so as to prevent temperature in the framework from continuously rising.

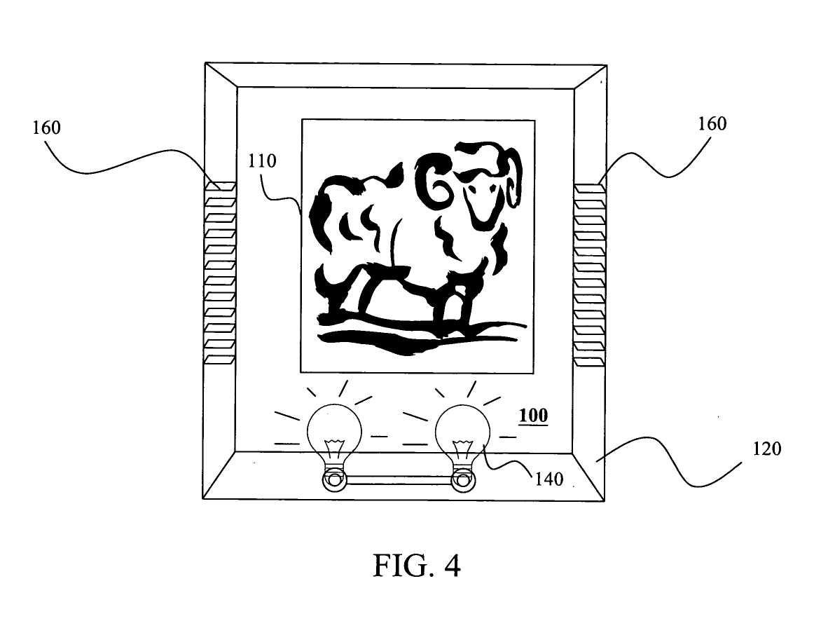

FIG. 4 is a frame structure with a built-in illumination device according to a third embodiment of the present invention. The frame structure includes a bottom plate 100, carrying a decorating object 110; a sidewall 120, having a sidewall height h determined depending on a 3D height of the decorating object 110, and surrounding the bottom plate 100; an outer framework 130, disposed along the sidewall 120 and covering the sidewall 120; and an illumination device 140, mounted on the sidewall 120 at any position, and providing an electric switch connected to an external power source (not shown).

As compared with the first embodiment, the frame structure with a built-in illumination device of the third embodiment emphasizes that the spirit of the present invention can also be achieved without using the reflection board 150. That is, for the frame structure with a built-in illumination device, the reflection board 150 is an optional structure, and is determined according to the practical requirements of the user. The electric switch can be a wireless remote control switch or can be directly connected onto a power socket. The reflection board 150 is one selected from among a combination of mirror glass, aluminum sheet, and foil, but it is not used to limit the scope of the present invention. The sidewall 120 also has a design of a heat dissipation hole 160, so as to prevent temperature in the framework from continuously rising.

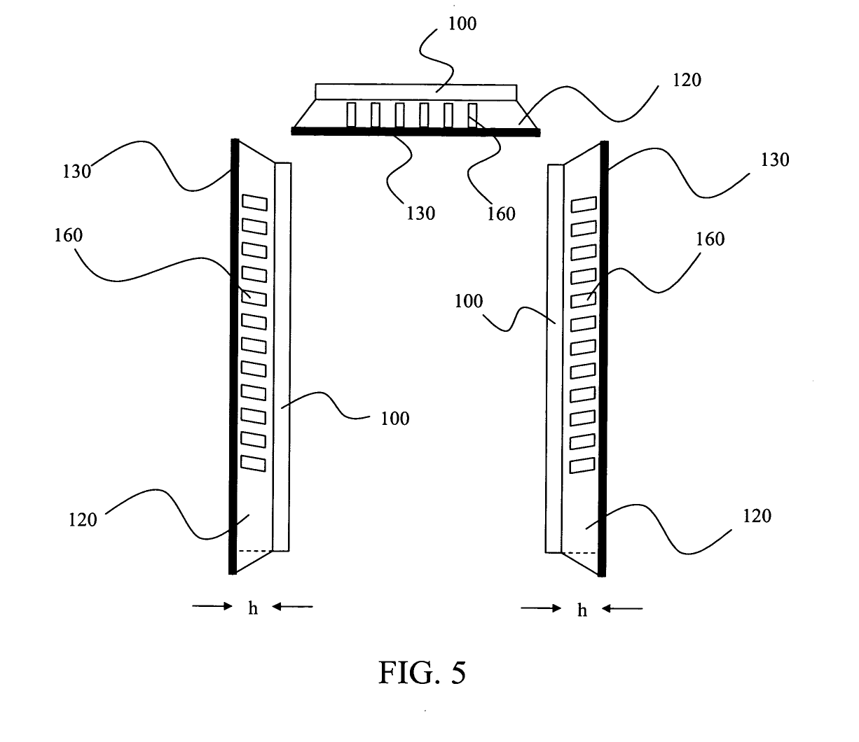

FIG. 5 is a schematic view of structures of upper, left, and right sides of the frame structure with a built-in illumination device of the present invention. The illumination device 140 is designed mostly at the lower portion of the frame structure, but it is only used to illustrate but not intended to limit the scope of the present invention. According to different requirements of design, the illumination device 140 can also be disposed on the upper, left, and right sides of the frame structure. For example, FIG. 5 illustrates a schematic structural view of the bottom plate 100, the sidewall 120, the outer framework 130, and the heat dissipation slot 160, in which the sidewall height is marked by “h”.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A frame structure with a built-in illumination device, comprising:
a bottom plate, carrying a decorating object;
a sidewall, having a sidewall height determined depending on a 3D height of the decorating object, and surrounding the bottom plate;
an outer framework, disposed along the sidewall and covering the sidewall;
an illumination device, mounted on the sidewall at any position, and providing an electric switch connected to an external power source; and
a reflection board, adhered onto the illumination device at a corresponding position, so as to reflect light rays emitted by the illumination device to enhance luminance.

2. The frame structure with a built-in illumination device as claimed in claim 1, wherein the sidewall has a heat dissipation hole.

3. The frame structure with a built-in illumination device as claimed in claim 1, wherein the electric switch is a wireless remote control switch.

4. The frame structure with a built-in illumination device as claimed in claim 1, wherein the external power source is an alternating current (AC) power source.

5. The frame structure with a built-in illumination device as claimed in claim 1, wherein the external power source is a battery.

6. The frame structure with a built-in illumination device as claimed in claim 1, wherein the reflection board is one selected from among a combination of mirror glass, aluminum sheet, and foil.

7. A frame structure with a built-in illumination device, comprising:
a bottom plate, carrying a decorating object;
a sidewall, having a sidewall height determined depending on a 3D height of the decorating object, and surrounding the bottom plate;
an illumination device, mounted on the sidewall at any position, and providing an electric switch connected to an external power source; and
a reflection board, adhered onto the illumination device at a corresponding position, so as to reflect light rays emitted by the illumination device to enhance luminance.

8. The frame structure with a built-in illumination device as claimed in claim 7, wherein the sidewall has a heat dissipation hole.

9. The frame structure with a built-in illumination device as claimed in claim 7, wherein the electric switch is a wireless remote control switch.

10. The frame structure with a built-in illumination device as claimed in claim 7, wherein the external power source is an AC power source.

11. The frame structure with a built-in illumination device as claimed in claim 7, wherein the external power source is a battery.

12. The frame structure with a built-in illumination device as claimed in claim 7, wherein the reflection board is one selected from among a combination of mirror glass, aluminum sheet, and foil.

13. The frame structure with a built-in illumination device as claimed in claim 7, further comprising a transparent protection cover covering above the sidewall.

14. A frame structure with a built-in illumination device, comprising:
a bottom plate, carrying a decorating object;
a sidewall, having a sidewall height determined depending on a 3D height of the decorating object, and surrounding the bottom plate;
an outer framework, disposed along the sidewall and covering the sidewall; and
an illumination device, mounted on the sidewall at any position, and providing an electric switch connected to an external power source.

15. The frame structure with a built-in illumination device as claimed in claim 14, wherein the sidewall has a heat dissipation hole.

16. The frame structure with a built-in illumination device as claimed in claim 14, wherein the electric switch is a wireless remote control switch.

17. The frame structure with a built-in illumination device as claimed in claim 14, wherein the external power source is an AC power source.

18. The frame structure with a built-in illumination device as claimed in claim 14, wherein the external power source is a battery.
